(19) United States
(12) Patent Application Publication
(10) Pub. No.: US 2017/0232553 A1
(43) Pub. Date: Aug. 17, 2017

(54) Welding Method for Joining Workpieces at a Lap Joint

(71) Applicant: Scansonic MI GmbH, Berlin (DE)

(72) Inventors: Pravin Sievi, Berlin (DE); Peter Fixemer, Berlin (DE)

(21) Appl. No.: 15/421,474

(22) Filed: Feb. 1, 2017

(30) Foreign Application Priority Data
Feb. 16, 2016 (DE) 102016102716.2
Apr. 25, 2016 (DE) 102016107581.7

(51) Int. Cl. B23K 26/21; B23K 26/06

(52) U.S. Cl. CPC B23K 26/21; B23K 26/0643; B23K 26/0626; B23K 2203/10

(57) ABSTRACT

A welding method for joining workpieces (10) made of hot-crack-sensitive materials at a lap joint by means of a remote laser welding device. A stitched weld seam (11) with the equivalent strength of a continuous weld seam (11) is produced from a plurality of weld seam sections (13). The power input of the laser beam (21) changes periodically between a minimum and a maximum value while the laser spot (22) describes an anharmonically oscillating pendulum motion on the workpiece surface plane (18). The welding and the formation of the weld seam sections (13) take place in the phases of the power input with the maximum value. The anharmonically oscillating pendulum motion takes place with an oscillation frequency of 2 to 25 Hz and an amplitude in the range of 1 to 20 mm. The method is intended for welding of hot-crack-sensitive aluminum materials, e.g. for production of automobile bodies.

### CROSS REFERENCE TO RELATED APPLICATIONS

This application claims the priority of DE 102016102716.2 filed on 2016 Feb. 16 and the priority of DE 102016107581.7 filed on 2016 Apr. 25; all applications are incorporated by reference herein in their entirety.

### BACKGROUND

The invention relates to a welding method for joining workpieces made of hot-crack-sensitive materials at a lap joint for producing a component, for example an automobile body.

Alloys from groups 5xxx (AlMg alloys) and 6xxx (AlMgSi alloys) are widely used in automobile body construction. These aluminum materials tend to form hot cracks during laser welding of I-seams. Qualitatively perfect I-seam welds are only possible within very small process parameter windows, for example for the laser power. It is inefficiently expensive to comply with these small process parameter windows in series production.

In particular, I-seams with large cross sections, i.e. wide and/or deep weld seams, cannot be produced by welding without specific procedures, such as, for example, welding with additional material. Consequently, hot-crack-sensitive materials cannot be used or can be used only to a limited extent if large cross-sections are necessary to ensure component strength.

Laser welding with additional materials requires the tactile contact of the welding device with the workpiece as well as an increased technical effort concerning the wire feeding. In order to avoid collisions, the components must be approached slowly. The increased cycle times reduce the cost effectiveness of the welding process.

A remote laser welding method is disclosed in DE 10 2015 002 427 A1, which makes it possible to weld a hot-crack-sensitive aluminum alloys at a lap joint without additional material with a combination of a fillet seam and I-seams. According to DE 10 2015 002 427 A1, the I-seams at the lap joint are short, sequentially successive, rectilinear or crimped weld seam sections of a stitched weld seam aligned parallel to the fillet weld seam. Between the weld seam sections, however, there are extensive areas without welding connection transverse to the stitched weld seam. The strength of the stitched weld seam is therefore not satisfactory and the additional fillet weld seam is required.

Furthermore, DE 10 2013 001 213 A1 discloses a beam welding method for joining metal sheets, in which the metal sheets are joined to one another by a plurality of overlapping weld joints at predetermined positions. According to the welding method known from DE 10 2007 063 456 A1 the energy input per unit length is varied.

### SUMMARY OF THE INVENTION

The invention relates to a welding method for joining workpieces (10) made of hot-crack-sensitive materials at a lap joint by means of a remote laser welding device. A stitched weld seam (11) with the equivalent strength of a continuous weld seam (11) is being produced from a plurality of weld seam sections (13). The power input of the laser beam (21) changes periodically between a minimum and a maximum value while the laser spot (22) describes an anharmonically oscillating pendulum motion on the workpiece surface plane (18). The welding and the formation of the weld seam sections (13) take place in the phases of the power input with the maximum value. The anharmonically oscillating pendulum motion takes place with an oscillation frequency of 2 to 25 Hz and an oscillation amplitude in the range of 1 to 20 mm. The method is intended for welding of hot-crack-sensitive aluminum materials, for example for production of automobile bodies.

### DETAILED DESCRIPTION

It is an object of the invention to provide a remote laser welding process with a large process parameter window suitable for series production without using a welding filler material, in that it is possible to join work pieces made of hot-crack-sensitive materials at a lap joint with a crack-free welding connection of closely welded seam sections. The weld seam sections should have at least the strength of an uninterrupted weld seam.

This object is achieved by means of a welding method for joining workpieces at a lap joint with a weld seam of several weld seam sections according to claim 1. Further embodiments of the invention are the subjects of the subclaims 2-10.

According to the invention, the welding is carried out with a remote laser welding device. A processing laser produces a laser beam, which is deflected by means of a scanner optics and impinges at a laser spot on a workpiece surface plane of the workpieces to be connected at the lap joint. The workpieces and the remote laser welding device are moved relative to each other by means of a feed device, for example a linear or rotary table, in a predetermined weld seam direction.

Using the scanner optics, the laser beam and, with it, the laser spot, are brought into an anharmonically oscillating pendulum motion. According to the invention, this is effected with an oscillation frequency of 2 to 20 Hz and with an oscillation amplitude in the range of 1 to 20 mm.

The power input by the laser beam into the workpieces at the laser spot is periodically changed with a power input period between a maximum value and a minimum value. The power input is the heat energy per time unit, which is introduced into the workpiece by the laser beam at the laser spot. For power inputs with the maximum value, the workpiece materials are melted at the lap joint with formation of weld metal. The minimum value lies below the power input required for melting the workpiece materials.

The change in the power input of the laser beam at the laser spot can be achieved by various measures, namely by varying the laser power, by focusing/defocusing the laser beam, or by changing the speed at which the laser spot moves on the workpiece. If, for example, the laser beam is guided over the workpieces at a very high speed, no melting of the workpiece materials takes place due to the low power input. Thus, the melting can be controlled solely by the change in the speed of movement of the laser spot.

By superposition of the anharmonically oscillating pendulum motion of the laser beam with the feed movement, the laser spot describes a path on the workpiece surface. The formation of the weld seam sections is effected on partial areas of this path during the power input of the laser beam with the maximum value by the melting of the workpieces at the lap joint. After subsequent solidification of the weld material in the weld seam sections, the workpieces are joined in a materially bonded manner.

During the power input with the minimum value, the laser beam strikes the workpieces without interaction. They remain un-welded in these sections of the path which are overrun.

The power input is coupled to the oscillating pendulum motion of the laser beam such that the oscillation period of the anharmonically oscillating pendulum motion is equal to the power input period or an integer multiple of the same.

According to the invention, linearly shaped, mutually parallel weld seam sections with respectively identical geometric dimensions are formed, wherein the projection in the workpiece surface plane perpendicular to the weld seam results in a continuous line. In this transverse projection to the weld seam this presents itself as an uninterrupted seam, formed by individual overlapping weld seam sections.

One of the advantages of the process is that heat-crack-sensitive materials—in particular AlMg and AlMgSi alloys—can be welded without cracks within a large process parameter window. This enables a stable, economical production process.

The alternating power input of the laser beam during the anharmonically oscillation pendulum motion with the oscillation frequency of 2 to 20 Hz prevents the formation of extended melting baths. Hot cracks cannot form when the melt solidifies into the narrowly extended weld seam sections.

The oscillating pendulum motion in this frequency range in conjunction with the alternating power input at the laser spot also allows a narrow spatial positioning of the weld seam sections with respect to each other. So the seam strength of the stitched weld seam is equal to a continuous weld seam.

The oscillating pendulum motion of the laser or of the laser spot is generated by active deflection units, typically rotatable mirrors, within the scanner optics. Because of their fixed axis of rotation, the deflection movements of a respective mirror are only possible in one direction. Preferably, the scanner optics are constructed in such a way that the laser beam is deflected transversely and/or longitudinally to the weld seam direction.

The anharmonically oscillating pendulum motion of the laser spot can take place transversely to the weld seam direction, longitudinally to the same or in a complex superimposition or sequence of transverse and longitudinal oscillating pendulum motions. This makes it possible in a variety of ways to adapt the arrangement and extent of the weld seam sections to the design requirements, for example in order to increase the cross-section of the weld seam to increase its strength.

In the case of an oscillating pendulum motion transversely to the weld seam direction, the weld seam sections can be arranged in parallel rows. Superposition of longitudinal and transverse pendulum motions enable sequences of weld seam sections which are angular oriented to the weld seam direction. In both cases, the seam strength can be easily increased by increasing the width of the weld seam.

In the case of an oscillating pendulum motion longitudinally to the weld seam direction, weld seams can be produced which consist continuously of welded material. At the end of the pendulum motion in the weld seam direction clearly spaced weld seam sections are produced and (after back pendulum movement) at the beginning of the oscillating pendulum motion in the weld seam direction sections between already solidified weld seam sections are welded. Weld seams produced in this embodiment of the process are characterized by high strength. They are also resistant to the penetration of fluid media.

It may be provided that the alternation of the power input between the maximum and the minimum value in the initial and end region of the respective weld seam section takes place continuously in a predetermined time. This is achieved, for example, by continuously increasing or reducing the laser power, by continuous focusing or defocusing of the laser beam, or by additionally superimposed motion forms of the laser spot. Solidification inhomogeneities, such as end craters occurring in the initial and end region of the weld seam sections, are avoided.

Specifically, semicircular motions of the laser beam along the respective weld seam section in counter-direction of the weld seam direction can be performed for “pull-out” the laser beam (i.e., reducing the power input in the end area of the weld seam section). This is particularly effective in combination with the continuous lowering of the laser power and/or the continuous defocusing of the laser beam in order to avoid end crater formation at the weld seam sections.

Furthermore, the movement of the laser spot in the initial region and/or in the end region of the respective weld seam section can be superimposed by a high-frequency additional oscillation movement which is generated by means of the scanner optics and which causes a widening of the weld seam section in the respective initial and/or end region. Preferably, the amplitude of the additional oscillation movement is 0.1 mm to 0.3 mm and the frequency of the additional oscillation movement is 100 Hz to 10 kHz. As a result of the additional oscillation movement, the laser beam is, for example, deflected in such a way that the laser spot moves along circular paths around the longitudinal axis of the respective weld seam section. The broadening of the weld seam sections in the initial and end region leads to an improvement in the joining strength by reducing the notch effect at the beginning or at the end of the weld seam sections.

In one embodiment of the invention, the power input on the path of the laser spot is controlled in such a way that the linearly shaped, mutually parallel weld seam sections have a respective longitudinal extent which is less than ten times the respective transverse extent. It has been found that the weld seams can be welded free of cracks within a particularly large process parameter window with said weld seam section dimensions.

The longitudinal expansion of the respective weld seam sections is advantageously limited to a maximum longitudinal extension of 10 mm when joining thin sheet metals. Preferably a length of the weld seam sections of 3 to 6 mm is selected.

In one embodiment of the invention, it can be provided that the distance between the weld seam sections and the welding seam section produced in time sequence previously is 35% to 65% of the transverse extent of the weld seam section.

Furthermore, the weld seam sections and their adjacent weld seam sections can overlap in projection in the workpiece surface plane perpendicular to the weld seam by 10% to 40%.

Weld seams produced accordingly have particularly close seam sections and have a high seam strength.

### BRIEF DESCRIPTION OF THE DRAWINGS

The invention is explained in more detail below with reference to exemplary embodiments and with reference to the schematic drawings. For this purpose it is shown in

FIG. 1: a remote laser welding device according to the state of the art during welding in the cross-sectional view transversely to the weld seam,

FIG. 2: a perspective view of a continuous weld seam according to the state of the art,

FIG. 3: a perspective view of several, angular orientated weld seam sections,

FIG. 4: a perspective view of a rectangular shaped weld seam of ellipsoidal weld seam sections arranged in a double row, and

FIG. 5: a perspective view of a linear shaped weld seam of ellipsoidal weld seam sections.

### DETAILED DESCRIPTION OF THE PREFERRED EMBODIMENTS

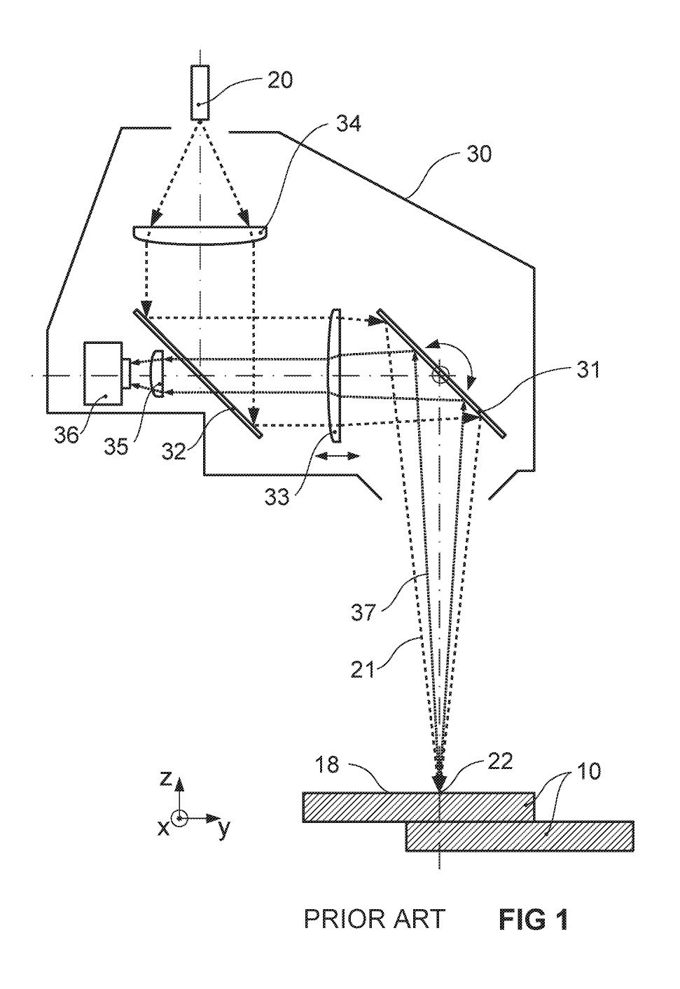

The remote laser welding device according to the state of the art in FIG. 1 consists of the processing laser 20 which produces the laser beam 21 and the scanner optics 30. The laser beam 21 is guides within the scanner optics 30 via the collimation unit 34, the passive deflection unit 32, the focusing unit 33 and the active deflection unit 31 and impinges the overlapping workpieces 10 to be welded on the workpiece surface plane 18 at the laser spot 22.

The measuring light 37 spreads from the workpiece surface plane 18 via the active deflection unit 31, the focusing unit 33, through the semi-transparent, passive deflecting unit 32 and the camera focusing unit 35 toward the camera 36. It is used for process monitoring and control, for example for the exact positioning of the laser spot 22 by means of edge detection at the lap joint.

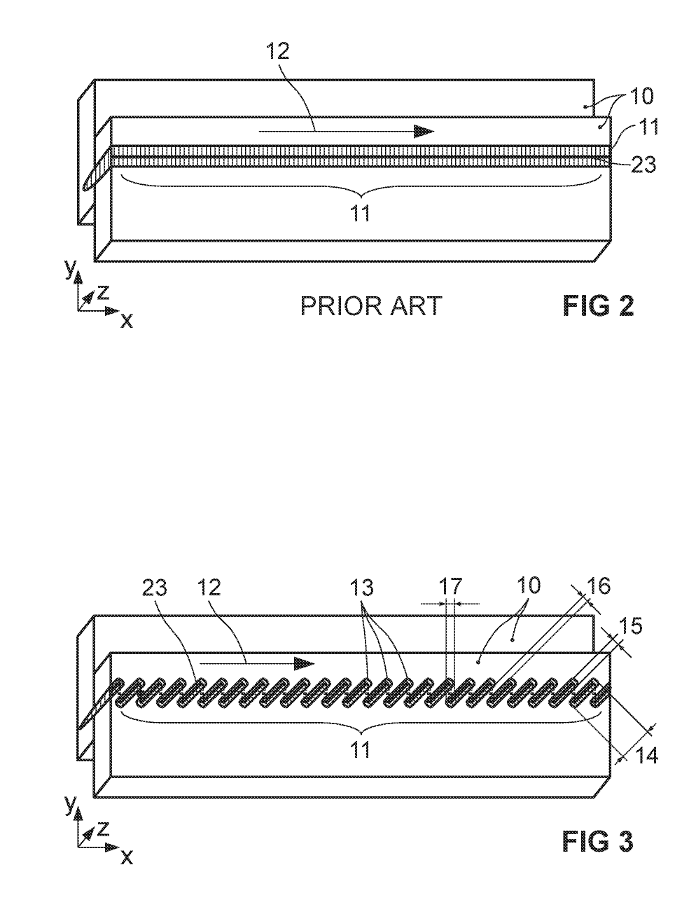

The continuous weld seam 11 according to the prior art in FIG. 2 runs parallel to the lap joint of the workpieces 10. To produce the weld seam 11, the laser spot 22 is guided along the path 23 in the weld seam direction 12.

According to the exemplary embodiment of the weld seam 11 in FIG. 3, the latter is composed of weld seam sections 13 oriented 45° to the weld seam direction 12. The respective transverse extension 15 here amounts to 25% of the longitudinal extension 14.

The path 23 of the laser spot 22 describes a sawtooth function during the welding of this weld seam 11. In the region of the solid lines of the path 23, the power input at the laser spot 22 operates with the maximum value, that is, the weld seam sections 13 are formed on these partial sections. In the region of the dotted lines of the path 23, the power input is reduced to the minimum value so that the workpiece material is not melted. The power input is varied between the maximum and the minimum value by a directed change in the speed of the laser spot 22 on the path 23, i.e., the laser spot 22 moves in the sections of the path 23, which are shown as solid lines slowly over the workpiece surface plane 18, that the power input is sufficient to weld the workpieces 10; in dotted areas of the path 23, the laser beam 21, on the other hand, is guided over the workpiece 10 so quickly that no melting occurs.

The arrow within the path 23 illustrates the motion of the laser spot 22. The orientation of the angular oriented weld seam sections 13 results from the superposition of the feed movement longitudinally with the weld seam direction 12 and the oscillating pendulum motion of the laser spot 22 transversely and longitudinally to the weld seam 12. The oscillating pendulum motion is performed with an oscillation frequency of 10 Hz and an oscillation amplitude of 2 mm.

The welding seam sections 13 successively produced on the path 23 of the laser spot 22 have a spacing 16 which is 60% of the transverse extension 15. In projection in the workpiece surface plane 18 perpendicular to the weld seam 11, adjacent weld seam sections 13 overlap each other by 25%.

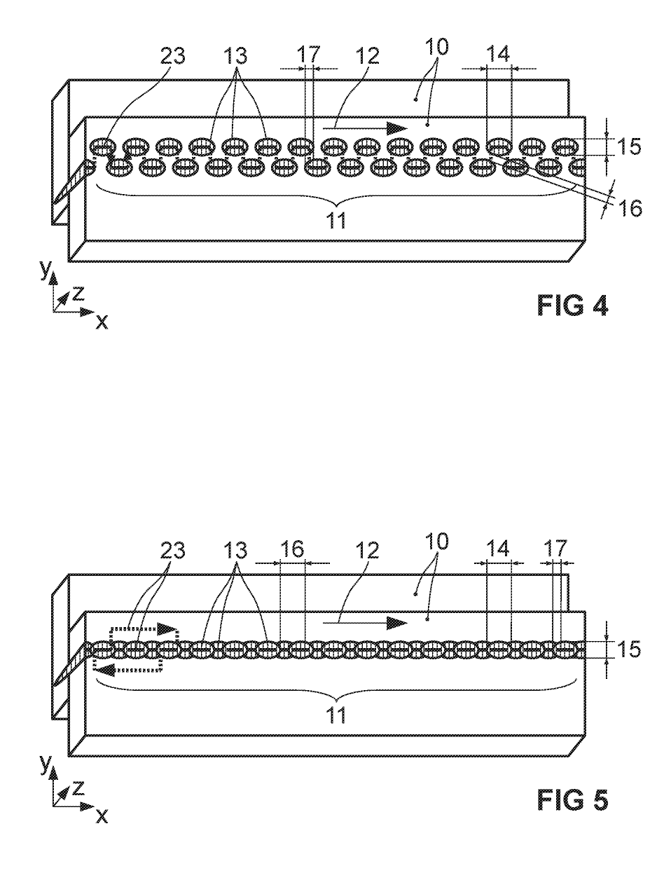

The weld seam 11 in the exemplary embodiment according to FIG. 4 consists of nearly point-shaped weld seam sections 13 arranged in a double row with a respective ratio of transverse extension 15 to longitudinal extension 14 of 70%. The reference numerals correspond to those in FIG. 3. The path 23 of the laser spot 22 follows a rectangular shaped function. The laser spot 22 performing an oscillating pendulum motion transversely to the weld seam direction 12 with an oscillation frequency of 15 Hz and an oscillation amplitude of 2 mm. The successively produced weld seam sections 13 have a spacing 16 of 30% of the transverse extent 15. The overlap 17 of adjacent weld seam sections 13 in projection in the workpiece surface plane 18 perpendicular to the weld seam 11 is 35%.

In order to produce the weld seam 11 according to the exemplary embodiment in FIG. 5, the laser spot 22 oscillates along the weld seam 11 with such a large oscillation amplitude that at the end of the pendulum motion in the weld seam direction 12 individual, clearly spaced weld seam sections 13 are produced and (after back pendulum motion) at the beginning of the pendulum motion in the weld seam direction 12, the sections between already solidified weld seam sections 13 are welded. The pendulum motion takes place on a straight line in the center of the weld seam 11. For the purposes of illustration, the oscillating pendulum motion with the minimum value of the power input is shown outside that straight line. The reference numerals, expansion and overlapping dimensions correspond to those in FIG. 4. The weld seam 11 according to FIG. 5 consist continuously of weld metal.

### LIST OF REFERENCE NUMERALS

10 Workpieces
11 Weld seam
12 Weld seam direction
13 Weld seam section
14 Longitudinal expansion of the weld seam section
15 Transverse expansion of the weld seam section
16 Spacing between successively welded weld seam sections
17 Overlap area of adjacent weld seam sections
18 Workpiece surface plane
20 Processing laser
21 Laser beam
22 Laser spot
23 Path of the laser spot
30 Scanner optics
31 Active deflection unit
32 Passive deflection unit
33 Focusing unit
34 Collimation unit
35 Camera focusing unit
36 Camera
37 Measuring light

1. A welding method for joining workpieces (10) at a lap joint with a weld seam (11) of a plurality of individual weld seam sections (13) by means of a remote laser welding device, comprising a processing laser (20) for producing a laser beam (21), a feed device for generating a feed movement in a predetermined weld seam direction (12) and a scanner optics (30), wherein
the laser beam (21) conducts an anharmonically oscillating pendulum motion with an oscillation frequency of 2 to 25 Hz which superimposes the feed movement, wherein a laser spot (22), generated by the laser beam (21) on a workpiece surface plane (18) of the workpieces (10) to be joined, oscillates back and forth with an oscillation amplitude in the range of 1 to 20 mm;
the power input of the laser beam (21) into the workpieces (10) is periodically changed between a maximum value and a minimum value, wherein the power input with the maximum value causes melting of the workpieces (10) at the lap joint and the minimum value lies below the power input required for that melting; and
the power input is coupled to the oscillating pendulum motion of the laser beam (21), wherein the oscillation period of the anharmonically oscillating pendulum motion is equal to the power input period or an integer multiple of the same,
wherein linearly shaped, mutually parallel weld seam sections (13) with respectively identical geometric dimensions are formed, wherein the projection in the workpiece surface plane (18) perpendicular to the weld seam (11) results in a continuous line.

2. A welding method according to claim 1, characterized in that the oscillating pendulum motion of the laser spot (22) takes place transversely to the weld seam direction (12).

3. A welding method according to claim 1, characterized in that the oscillating pendulum motion of the laser spot (22) takes place longitudinally to the weld seam direction (12).

4. A welding method according to claim 1, characterized in that the oscillating pendulum motion of the laser spot (22) is a superposition or a sequence of motion segments transversely and longitudinally to weld seam direction (12).

5. A welding method according to claim 1, characterized in that the change of the power input occurring in the initial region and/or in the end region of the respective weld seam section (13) takes place continuously between the maximum value and the minimum value within a predetermined time.

6. A welding method according to claim 5, characterized in that semicircular movements of the laser spot (22) are carried out in the end region along the respective weld seam section (13) in counter-direction to the weld seam direction (12) and simultaneously the laser beam (21) is continuously defocused and/or the laser power is continuously reduced.

7. A welding method according to claim 1, characterized in that a high-frequency additional oscillation movement, which is generated by means of the scanner optics, is superimposed to the motion of the laser spot (22) in the initial region and/or in the end region of the respective weld seam section (13) to produce a widening of the weld seam section (13) in the respective initial and/or end region.

8. A welding method according to claim 1, characterized in that the linearly shaped weld seam sections (13) which are parallel to one another have a respective longitudinal extent (14) which is less than ten times their respective transverse extent (15).

9. A welding method according to claim 1, characterized in that spacing (16) of one of the weld seam sections (13) to the welding seam section (13) produced in time sequence previously is 35% to 65% of the transverse extent (15) of the weld seam section (13).

10. A welding method according to claim 1, characterized in that adjacent weld seam sections (13) overlap each other in projection in the workpiece surface plane perpendicular to the weld seam by 10% to 40%.
